(19) United States
(12) Patent Application Publication
(10) Pub. No.: US 2009/0322506 A1
(43) Pub. Date: Dec. 31, 2009

(54) METHOD AND APPARATUS FOR DRIVER STATE DETECTION

(76) Inventor: Carsten Schmitz, Bendorf (DE)

Correspondence Address: KENYON & KENYON LLP, ONE BROADWAY, NEW YORK, NY, 10004, US

(21) Appl. No.: 12/304,665

(22) PCT Filed: Sep. 5, 2007
(86) PCT No.: PCT/EP2007/059291

§ 371 Date: Jul. 30, 2009

(30) Foreign Application Priority Data
Nov. 3, 2006 (DE) 10 2006 051 930.2

(51) Int. Cl. B60Q 1/00

(52) U.S. Cl. 340/439

(57) ABSTRACT

In a method and an apparatus for driver state detection, a signal characterizing the driver state is derived from the frequency of minima in the time profile of a variable that represents the lane-holding behavior of the driver, in particular the “time to line crossing,” the time required until the lane marking is crossed.

### FIELD OF THE INVENTION

The present invention relates to a method and an apparatus for driver state detection.

### BACKGROUND INFORMATION

DE 102 10 130 describes a method and an apparatus for driver warning in which a degree of driver attention is taken into account. This degree of attention is derived from the steering angle, in particular from a change in the steering angle, e.g. in its gradient and/or the frequency of changes in angle and/or the separation between successive changes in steering angle. In addition, further influencing variables for detection of the driver's state are described, for example the gas pedal position and changes therein.

DE 102004039142 describes so-called lane departure warning systems in which a determination is made of the time span that the vehicle will require in order to depart from the lane if the present vehicle state is maintained (time to line crossing, TLC). If this value falls below a limit value, the driver is warned.

### SUMMARY

A considerable improvement in driver state detection, in particular in the reliability thereof, is achieved by the fact that the signal signaling the driver state is derived from a variable that indicates the frequency with which extreme values occur in the time profile of a variable representing the driver's lane behavior. In the context of a drowsy or inattentive driver, such a variable exhibits a characteristic behavior that can be evaluated for driver state detection.

Evaluation of this variable provides satisfactory results in terms of reliability and hit rate. The high rate of correct classification of a drowsy driver is particularly advantageous. Corresponding evaluation of the “time to line crossing” variable is particularly advantageous.

The use of such a criterion yields a very high hit rate for detection of a drowsy driver. This method offers particular advantages in conjunction with driver assistance systems that are controlled as a function of the ascertained driver state, for example that adjust thresholds for triggering a warning to the driver, or the nature of the warning (e.g. loud, soft), as a function of the driver's state.

Particular advantages are achieved by the use of a neural classifier for driver state detection, with the aid of which classifier the aforesaid variable can be can be combined with other variables (constant steering wheel position with no steering correction and/or constant steering wheel position with steering correction, as well as other variables as applicable) for driver state detection.

Further advantages are evident from the description below of exemplifying embodiments and from the dependent claims.

Example embodiments of the present invention will be explained in further detail below with reference to the drawings.

### BRIEF DESCRIPTION OF THE DRAWINGS

FIG. 1 shows an apparatus for driver state detection.

FIG. 2 is a flow diagram that sketches the implementation of a method for driver state detection as a computer program.

FIG. 3 lastly, shows a driver state detection system having a neural classifier.

### DETAILED DESCRIPTION

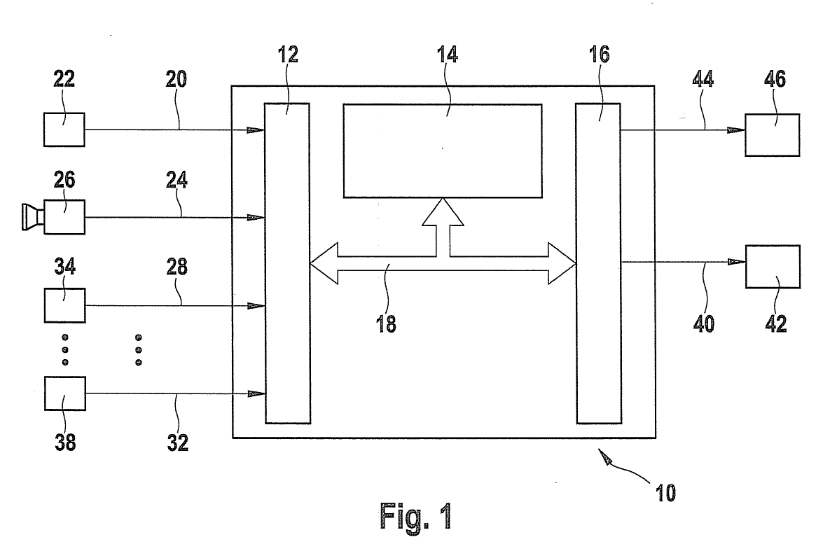

FIG. 1 shows an apparatus for driver state detection. Substantial constituents therein are an electronic control unit 10 that is made up substantially of components such as an input circuit 12, computer 14, and output circuit 16. These components are connected to a bus system 10 for mutual exchange of information and data. Various sensors are connected, preferably via a bus system, to input circuit 12. In an example embodiment, the sensor suite described below is applied in conjunction with the procedure described below. Alternatively thereto, in another embodiment, a different sensor suite that senses corresponding variables, or from whose measured variables corresponding variables can be derived, is used. In addition, further sensors whose signals are evaluated in the context of other functionalities can be linked to the apparatus. A steering angle sensor 22 is linked to input circuit 12 via a supply lead 20. A video camera 26, which senses the scene in front of the vehicle and is the basis for detecting lane edge markings, is connected to input circuit 12 via a further input lead 24. Also connected via input leads 28 to 32 are further sensors 34 to 38, for example for sensing the gas pedal position, extent of brake actuation, etc., the signals of which sensors are of significance in an embodiment of the invention. Via output circuit 16, information is outputted e.g. via an output lead 40, a warning lamp 42 or an information display 42 are activated, by way of which the driver state may be indicated. In one embodiment, an actuator 46 is activated via an output lead 24 in order to influence the steering angle of the vehicle, the acceleration and/or the deceleration of the vehicle.

In an example embodiment, part of the apparatus set forth in FIG. 1 is a driver assistance system that operates on the basis of a lane detection system such as, for example, the so-called lane departure warning system. Such systems are described, for example, in the documents cited above. With these systems, based on the image from the video camera the sequence of lane markings is detected, the position of the own vehicle or the expected position of the own vehicle is compared with said lane edge markings, and a warning is outputted to the driver or an input into the steering system is effected if the vehicle departs, or is about to depart, from the lane. A parameter that is ascertained in this connection is the lateral separation of the vehicle from the lane edge marking or from a boundary derived therefrom.

Satisfactory results can be obtained from a driver state detection by taking into account a variable that represents the driver's lane behavior. A driver state detection is performed by checking said variable and identifying the frequency of extreme values, preferably minima, in the time profile of such a variable. The more frequently the minima occur, the more readily it can be assumed that a driver is drowsy or inattentive. If the frequency of the minima is compared with a limit value, a drowsy or inattentive driver can be inferred when the limit value is exceeded. A variable that is particularly suitable is the sensed lateral separation, or the time needed for the vehicle to reach the lane boundary (time to line crossing, TLC).

In an example embodiment, a variable representing the steering wheel movement by the driver is also used in connection with the procedure described below for driver state detection. Depending on the embodiment, a variety of sensors are available for ascertaining such a variable, for example a sensor for sensing the steering wheel angle, a sensor for sensing wheel positions, a sensor for sensing the yaw rate, a sensor for sensing the transverse acceleration, etc.

A further possibility for detecting the driver state may be derived therefrom by checking the profile of at least one actuation signal of the driver, in particular the steering angle or a signal comparable therewith, and in the context of a typical behavior of said signal inferring inattentiveness or, for example, momentary sleep on the part of the driver. In a preferred exemplifying embodiment, for example, the time profile of the steering angle is sensed and checked. If what results is firstly a steering angle rate in the region of zero with a subsequent steering correction and a steering rate greater than a specific limit value, it is then assumed that the driver is inattentive or fatigued. This behavior represents a typical reaction to inattention on the part of the driver, who reacts nervously to his or her incorrect driving by acting vigorously on the steering wheel and performing a steering correction. It is also important in this context that prior to the sudden steering action, the driver exhibits substantially no reaction at the wheel.

An improvement in driver state detection is achieved by the fact that not only is the occurrence of such a behavior pattern checked, but a measurement of the frequency and/or time interval of such a behavior pattern is also monitored, and a driver is assumed to be drowsy or inattentive when such steering corrections occur more frequently than has been predefined.

Particularly accurate driver state detection results are obtained with a combination of these variables, namely when a high frequency of minima in the profile of a separation variable (lateral separation or TLC) with respect to the lane edge marking, or a threshold derived therefrom, is detected in the context of a constant steering angle and subsequent steering correction.

Further variables that are evaluated in order detect driver fatigue are, for example, a standard deviation of the lateral position of the vehicle in the lane, evaluation of steering rates, evaluation of eyelid blinking frequency and/or time during which the driver's eyes are closed, or also the evaluation of vehicle data such as gas pedal position, etc. Some of these criteria are known to one skilled in the art under the term PERCLOS.

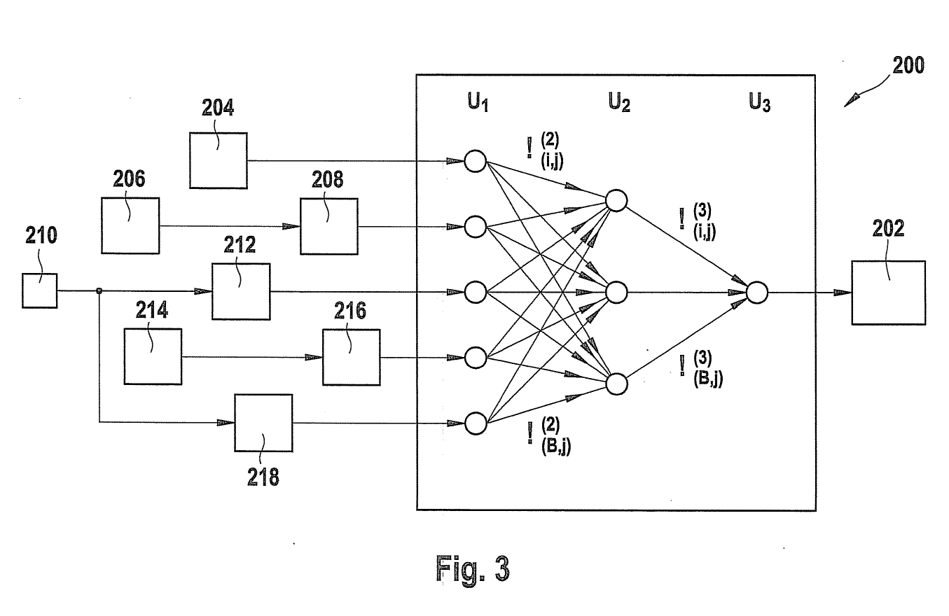

It is provided that a combination of criteria as presented above produces a further improvement, and that an indication of the driver state can be discovered from a combination of all or some of the aforementioned features. A neural classifier, to which the features to be evaluated are delivered, is used in this context. An example of one such neural classifier is shown in FIG. 3. The aforesaid signals, which appear as functions of time, are delivered to the classifier. In a preferred exemplifying embodiment, not all these features are used, but only an evaluation of the extreme values in the time profile of a variable indicating the driver's lane behavior (separation from lane edge marking, TLC) or a threshold derived therefrom, and the frequency of constant steering wheel positions with and/or without subsequent steering correction. Even with these, appreciable results can be achieved.

One important finding is observation of the profile of the lateral separation from a lane edge marking, or a variable derived therefrom, or even a comparable variable such as, for example, the time required for the vehicle, given a constant vehicle state, to go beyond the lane edge marking or a threshold derived therefrom. The driver state is preferably derived from the frequency of the minima in the profile of the curve of such a variable. If the frequency of these minima within a certain time span exceeds a predefined limit value, it is assumed that the driver is drowsy and/or inattentive.

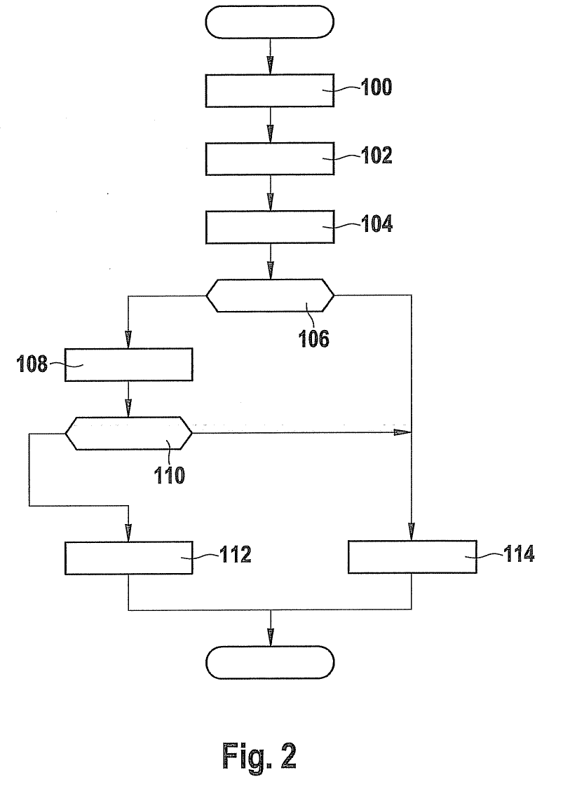

FIG. 2 shows a corresponding procedure with reference to a flow diagram. The flow diagram shown outlines the program of control unit 10, which program is executed at predefined points in time. Firstly, in step 100, the ascertained value (TLC) of the time span required by the vehicle, in the context of a substantially constant vehicle state, to go beyond the lane edge marking, or a threshold derived therefrom, is read in. In step 102 this value is stored together with the time at which it was sensed. In step 104 a calculation is then made, from the present value and previous ones, as to whether an extreme value of the curve profile of this variable (TLC) is present. This extreme value is generally a minimum value of the value profile. In an embodiment, the calculation is performed by differentiating over a predefined number of values. Other methods for ascertaining extreme values in a series of time-related values can also be utilized. Step 106 then checks whether a minimum of the curve is present. In an example embodiment, no distinction is made between the right and the left side of the vehicle; consideration of one side of the vehicle is sufficient. In another example embodiment, the program outlined here is executed for the left and for the right edge marking, the respective minima are ascertained, and the frequency is determined from both sides. If a minimum is present in step 106, a counter is incremented in that case in step 108. This counter has the property that it is incremented each time a minimum of the TLC curve is detected, but is decremented after a certain time has elapsed. This allows the frequency of the occurrence of minima in the TLC curve within a certain time span to be identified. The next step 110 checks whether the counter status has reached or exceeded a specific value. If so, then according to step 112 the driver state is classified as tired or inattentive, and the program outlined is executed again at the next point in time. In the case of negative answers in step 106 or 110, the driver status is classified in step 114 as attentive, whereupon the program outlined is repeated with step 100 at the next point in time.

In a further advantageous exemplifying embodiment, as a supplement to the determination of minima in the TLC curve, an evaluation is also made of the frequencies of a constant steering wheel position for longer periods of time while driving, and/or of the frequencies of a constant steering wheel position for longer periods of time while driving, with subsequent steering correction. In this context, the driver is classified as inattentive if at least two of these features exceed predetermined limit values. Lack of movement of the steering wheel during longer periods of time is derived, for example, from steering wheel changes or from changes in corresponding variables, if they lie within a defined tolerance band for a predefined period of time.

Also particularly advantageous for appraising an inattentive driver state is a combination of the frequency of the minima of the TLC curve with lack of movement of the steering wheel while lateral thresholds are being exceeded. If the vehicle exceeds the ascertained lane edge marking or a threshold derived therefrom, and if in the meantime the steering wheel does not move or moves only within the context of defined tolerances, it is assumed that a driver is inattentive if the frequency of the minima of the TLC curve has simultaneously reached or exceeded a specific magnitude.

All these procedures produce satisfactory classification results.

A further improvement in classification results is obtained from the use of a neural classifier that evaluates at least the aforesaid features of the minima of the TLC curve and the frequencies of constant steering wheel positions with and without steering correction. In an advantageous enhancement, further variables are linked, for example the steering rates that are ascertained based on a steering wheel angle or on a steering angle sensor, yaw-rate or transverse-acceleration sensor, an inattentive driver being inferred in a context of abrupt steering movements, i.e. high steering rates. Determination of a standard deviation of the lateral position of the vehicle in the lane is an important variable, as are the variables of accelerator-pedal and/or brake-pedal actuation, and/or monitoring of the eyelid blink frequency or average duration of closed eyelids, referred to in the literature as PERCLOS.

FIG. 3 shows the configuration of a corresponding apparatus for driver fatigue detection using a neural classifier 200. The neural classifier embodied in FIG. 3 is multi-layered. As the output variable of level U3 of the neural classifier, a classification signal is outputted and is delivered to a display and/or to a further control system 202, the classification signal indicating an inattentive or tired driver. In the preferred exemplifying embodiment, a signal is present for a driver assumed to be tired, and no output signal is present for a driver classified as attentive. The input variables inputted into first level U1 of neural classifier are, in a preferred embodiment, the features referred to above as PERCLOS, i.e. an indication of the eyelid blinking frequency and the time during which the lids are closed, and/or an indication of the manner in which operating elements such as the gas pedal or brake pedal are actuated. The standard deviation of the lateral position of the vehicle in the lane is also inputted. A third input variable is an indication of the magnitude of the steering rates; the fourth input variable is represented by the frequency of minima in the TLC curve; and the fifth and last input variable is an indication of the frequency of a constant steering wheel position with and/or without over-reactive steering corrections. The latter two features already produce good classification results, while the additional three features recited first represent a further improvement in driver state detection, although in some exemplifying embodiments these features, or one or more thereof, can be omitted.

The signal delivered to the first input of neural classifier 200, regarding the magnitude of the eyelid blink frequency or the time during which the eyelids are closed, is acquired by a driver observation camera 204 with corresponding image evaluation, and a magnitude for the aforesaid criteria is calculated and delivered to the neural classifier. If the actuation rate of the gas pedal and/or brake pedal is evaluated instead of or in addition to the eyelid blink frequency or the time during which the eyelids are closed, this occurs as a function of the corresponding position signals, in which context means 204 then transmits a magnitude for the actuation rate to the neural classifier.

The second input variable represents an indication of the lateral separation of the vehicle from an edge marking. For example, by way of a camera 206 plus image evaluation unit mounted in the vehicle, the lane is sensed and the position of the vehicle within the lane is calculated. The individual measurement results are then averaged in calculation unit 208, and the standard deviation of the averaged measured values is ascertained and delivered to the neural classifier. The idea behind this is that the standard deviation increases as the driver becomes more inattentive, since he or she is moving the vehicle back and forth within its lane.

A further input variable is the steering rate. In measurement device 210, the steering wheel angle, steering angle, or one of the aforesaid comparable signals is ascertained, and the steering rate is ascertained in calculation unit 212. This variable is then delivered to neural classifier 200.

The frequency of minima in the TLC curve is additionally provided as a fourth input variable. In this context a determination is made, for example by way of a driver assistance function (lane departure warning system 214) of the time required by the vehicle, without steering correction, to go beyond to the lane edge markings or a threshold derived therefrom. From these variables, a time profile is stored as set forth above, and the frequency of minima in this curve is ascertained in calculation unit 216. This variable is then delivered to the neural classifier.

Also provided is a calculation unit 218 to which the steering angle or a variable comparable thereto is delivered, on the basis of which variable the calculation unit 218 derives the frequency of constant steering wheel positions for longer periods of time, as mentioned above, with and/or without subsequent steering correction. A corresponding variable is delivered to neural classifier 200 as a fifth input variable.

In another exemplifying embodiment, what is delivered to neural classifier 200, instead of the absolute variables, are values between 0 and 1 that have been generated by comparing the ascertained variables with threshold values. For example, 1 means that based on the one variable, it can be reliably assumed that the driver is inattentive. This value falls between 0 (attentive) and 1 (inattentive) depending on the degree of detection.

In first level U1 of the neural classifier, the individual delivered variables are weighted with weights stored in the neural classifier, and transmitted to the neurons of the second level. There the results of the first level (also values between 0 and 1) are combined, preferably multiplied, and weighted with weights stored in the neurons of level 2. The results of level 2 are then transmitted into the neuron of level 3, which once again combines the results of level 2 and generates therefrom, using the weight stored therein, the “fatigue” or “inattention” output signal.

The weights (threshold values for evaluation of the input variables) of the individual neurons are determined in the context of a training operation. This training is based on the results of series of experiments in which the behavior of the particular operating variables being evaluated is plotted against the actual driver state. Using a learning algorithm, the weights of the neurons are optimized so as to produced the greatest possible success in classifying the experimental data.

1-9. (canceled)

10. A method for driver state detection, comprising:
generating a signal signaling the driver state by deriving from a variable that indicates a frequency with which extreme values occur in a time profile of a variable representing a lane behavior of a driver.

11. The method according to claim 10, wherein the variable is at least one of (a) a time required until the vehicle goes beyond lane edge markings, (b) a threshold derived therefrom, and (c) a time required until the vehicle goes beyond lane edge markings without substantial changes in the vehicle state.

12. The method according to claim 10, wherein the extreme values are minima of the time profile.

13. The method according to claim 10, wherein a frequency of time spans with a substantially constant steering wheel position is additionally evaluated for derivation of the signal for the driver state.

14. The method according to claim 10, wherein exceedance of a defined lateral separation from at least one of (a) a lane edge marking and (b) a threshold value derived therefrom, while at least one of (a) a steering wheel position and (b) a steering angle remains constant, is further evaluated.

15. The method according to claim 10, wherein evaluation of the ascertained variables that represent the driver state is performed by a neural classifier.

16. The method according to claim 15, wherein a variable is supplied to the neural classifier, which represents a frequency of minima, which represents a frequency of a constant steering wheel position with overreactive steering correction.

17. The method according to claim 16, wherein variables including at least one of (a) steering rates, (b) a standard deviation of a lateral position of the vehicle in a lane, (c) eyelid blink frequencies, (d) eyelid closure times, (e) gas pedal actuation rates and (f) brake pedal actuation rates are additionally supplied.

18. An apparatus for driver state detection, comprising:
a computer unit adapted to generate a signal characterizing a driver state, the computer unit configured such that the signal characterizing the driver state is derivable from a frequency of extreme values in a time profile of a variable that represents lane-holding behavior of a driver.
